(19) United States
(12) Patent Application Publication
(10) Pub. No.: US 2024/0022312 A1
(43) Pub. Date: Jan. 18, 2024

(54) CONTROL APPARATUS, CONTROL METHOD, AND RECORDING MEDIUM

(71) Applicant: NEC Corporation, Tokyo (JP)

(72) Inventors: Jun SHIKIDA, Tokyo (JP); Kazushi MURAOKA, Tokyo (JP)

(73) Assignee: NEC Corporation, Tokyo (JP)

(21) Appl. No.: 18/218,887

(22) Filed: Jul. 6, 2023

(30) Foreign Application Priority Data
Jul. 13, 2022 (JP) 2022-112145

(51) Int. Cl. H04B 7/08; H04B 7/0408

(52) U.S. Cl. CPC H04B 7/088; H04B 7/0408

(57) ABSTRACT

A control apparatus controls a communication with a plurality of wireless terminals using a plurality of beams. The control apparatus calculates an index indicating a relationship between the plurality of beams, on the basis of a first information about a success/failure of a communication with at least two of the plurality of wireless terminals, and a second information indicating a combination pattern of at least two of the plurality of beams that are used a communication whose success/failure is indicated by the first information; and selects, from among the plurality of wireless terminals and the plurality of beams, a combination of at least one wireless terminal serving as a communication target and at least one beam used to communicate with the at least one wireless terminal, on the basis of the index.

### INCORPORATION BY REFERENCE

This application is based upon and claims the benefit of priority from Japanese Patent Application No. 2022-112145, filed on Jul. 13, 2022, the disclosure of which is incorporated herein in its entirety by reference.

### TECHNICAL FIELD

Example embodiments of this disclosure relates to a control apparatus and a control method that are configured to control a communication with a plurality of wireless terminals using a plurality of beams, and a computer program and a recording medium.

### BACKGROUND ART

In order to realize a high-speed and large-capacity wireless communication, utilization of a high-frequency band is advancing where a wide bandwidth can be secured. For example, a millimeter-wave band is supported in the fifth-generation mobile communication system (5G). In addition, in the sixth-generation mobile communication system (6G), a terahertz wave band that is higher than the millimeter wave band is expectedly supported.

In order to effectively use the high-frequency band, it is considered to use a base station apparatus that allows a plurality of wireless apparatuses, each of which is configured to communicate with a wireless terminal by using a beam, to be distributed. The wireless apparatus may be referred to as a Transmission and Reception Point (TRP). The distribution arrangement of the plurality of wireless apparatuses increases the opportunity that a communication environment between at least one wireless apparatus provided by the base station apparatus and the wireless terminal is a line-of-sight environment. Therefore, it is possible to solve such a problem of the high frequency band that a radio wave is hardly diffracted and is easily shielded.

In addition, beamforming may be applied to each of the plurality of wireless apparatuses. The beamforming is a technique/technology of adjusting at least one of an amplitude and a phase of a radio frequency signal transmitted by the wireless apparatus to control the directivity of a beam formed by an antenna of the wireless apparatus. The use of the beamforming makes it possible to intensify the radio wave by directing the beam in a specific direction, and makes it possible to solve such a problem of the high-frequency band that a propagation loss is large. Here, when the plurality of wireless apparatuses are distributed, a problem could be the interference of the beam between at least two of the plurality of wireless apparatuses. For example, in a situation that at least two coverage areas respectively covered by the at least two wireless apparatuses overlap each other, when the at least two wireless apparatuses communicate simultaneously with at least two different wireless terminals disposed in an overlapping area of the at least two coverage area, the interference of the beam may occur. When the interference of the beam occurs between at least two wireless apparatuses as described above, the distribution arrangement of the plurality of wireless apparatus is less effective. For this reason, it is desirable to reduce the interference of the beam between at least two wireless apparatuses.

Patent Literature 1 described below discloses a method of selecting a wireless terminal that communicates with each of a plurality of wireless apparatuses so as to reduce the interference of the beam between the plurality of wireless apparatuses as much as possible. Specifically, first, one beam and one wireless apparatus that allow a maximum received power are specified for each wireless terminal. Then, on the basis of the position of the one specified wireless apparatus and the direction of the one specified beam, the position of each wireless terminal is estimated. Then, by using the estimated position of the wireless terminal, an angle difference viewed from one wireless apparatus is calculated between the direction of one wireless terminal with which the one wireless apparatus communicates and the direction of another wireless terminal with which another wireless apparatus communicates. That is, calculated as the angle difference is an angle formed by a virtual axis that connects one wireless apparatus and one wireless terminal with which the one wireless apparatus communicates, and a virtual axis that connects one wireless apparatus and another wireless terminal with which another wireless apparatus communicates. The method described in Patent Literature 1 allows a reduction in the interference of the beam between the plurality of wireless apparatuses by selecting a wireless terminal that communicates with each wireless apparatus so as to increase the angle difference calculated in this way, as much as possible.

As other background art documents related to the present application, Patent Literature 2 to Patent Literature 4 are cited.

### BACKGROUND ART DOCUMENTS

### Patent Literature

Patent Literature 1: International Publication No. WO2022/044328 pamphlet
Patent Literature 2: International Publication No. WO2018/151288 pamphlet
Patent Literature 3: JP2022-518198A
Patent Literature 4: JP2018-137552A

### SUMMARY

The method described in Patent Literature 1, however, estimates the position of the wireless terminal on the assumption that the communication environment between the wireless apparatus and the wireless terminal is a line-of-sight environment. Therefore, the method described in Patent Literature 1 may not allow a reduction in the interference of the beam between the plurality of wireless apparatuses when the communication environment between the wireless apparatus and the wireless terminal is a non-line-of-sight or over-the-horizon environment. That is, there is a possibility that it is hardly possible to reduce the interference of a plurality of beams used to communicate with a plurality of wireless terminals.

It is an example object of this disclosure to provide a control apparatus, a control method, a computer program, and a recording medium that can solve the technical problems described above. As an example, it is an example object of this disclosure to provide a control apparatus, a control method, a computer program, and a recording medium that are capable of reducing the interference of a plurality of beams used to communicate with a plurality of wireless terminals. A control apparatus according to an example aspect of this disclosure is a control apparatus that controls a communication with a plurality of wireless terminals using a plurality of beams, the control apparatus including: at least one memory configured to store instructions; and at least one processor, the at least one processor being configured to execute the instructions to: calculate an index indicating a relationship between the plurality of beams, on the basis of a first information about a success/failure of a communication with at least two of the plurality of wireless terminals, and a second information indicating a combination pattern of at least two of the plurality of beams that are used a communication whose success/failure is indicated by the first information; and select, from among the plurality of wireless terminals and the plurality of beams, a combination of at least one wireless terminal serving as a communication target and at least one beam used to communicate with the at least one wireless terminal, on the basis of the index.

A control method according to an example aspect of this disclosure is a control method that controls a communication with a plurality of wireless terminals using a plurality of beams, the control method including: calculating an index indicating a relationship between the plurality of beams, on the basis of a first information about a success/failure of a communication with at least two of the plurality of wireless terminals, and a second information indicating a combination pattern of at least two of the plurality of beams that are used a communication whose success/failure is indicated by the first information; and selecting, from among the plurality of wireless terminals and the plurality of beams, a combination of at least one wireless terminal serving as a communication target and at least one beam used to communicate with the at least one wireless terminal, on the basis of the index.

A computer program according to an example aspect of this disclosure is a computer program that allows a computer to execute a control method that controls a communication with a plurality of wireless terminals using a plurality of beams, the control method including: calculating an index indicating a relationship between the plurality of beams, on the basis of a first information about a success/failure of a communication with at least two of the plurality of wireless terminals, and a second information indicating a combination pattern of at least two of the plurality of beams that are used a communication whose success/failure is indicated by the first information; and selecting, from among the plurality of wireless terminals and the plurality of beams, a combination of at least one wireless terminal serving as a communication target and at least one beam used to communicate with the at least one wireless terminal, on the basis of the index.

### BRIEF DESCRIPTION OF THE DRAWINGS

FIG. 1 is a block diagram illustrating a configuration of a control apparatus in a first example embodiment;

FIG. 2 is a flowchart illustrating a flow of operation of the control apparatus in the first example embodiment;

FIG. 3 is a block diagram illustrating an overall configuration of a wireless communication system in a second example embodiment;

FIG. 4 is a block diagram illustrating a configuration of a wireless terminal in the second example embodiment;

FIG. 5 is a block diagram illustrating a configuration of a base station apparatus in the second example embodiment;

FIG. 6 is a block diagram illustrating a configuration of a control apparatus in the second example embodiment;

FIG. 7 is a block diagram illustrating a configuration of a radio signal processing unit in the second example embodiment;

FIG. 8 is a block diagram illustrating a configuration of a scheduling unit in the second example embodiment;

FIG. 9 is a block diagram illustrating a configuration of a wireless apparatus in the second example embodiment;

FIG. 10 is a flowchart illustrating a flow of am index calculation operation of calculating an index;

FIG. 11 is a diagram illustrating an example of the index;

FIG. 12 is a flowchart illustrating a flow of a combination selection operation of selecting a combination of the wireless terminal and a beam on the basis of the index;

FIG. 13 is a diagram illustrating a combination of software and hardware for realizing the functions of the control apparatus described in the first example embodiment.

### EXAMPLE EMBODIMENTS

Hereinafter, a control apparatus, a control method, and a computer program according to example embodiments of will be described with reference to the drawings.

### <1> First Example Embodiment

First, a control apparatus, a control method, and a computer program in a first example embodiment will be described. In the following description, the control apparatus, the control method, and the computer program in a first example embodiment will be described by using a control apparatus 1000 to which the control apparatus, the control method, and the computer program in the first example embodiment are applied.

The control apparatus 1000 is an apparatus that is configured to control a communication with a plurality of wireless terminals by using a plurality of beams. To control the communication with the plurality of wireless terminals by using the plurality of beams, the control apparatus 1000 includes a calculation unit 1001 and a selection unit 1002, as illustrated in FIG. 1 that illustrates a configuration of the control apparatus 1000.

At least one of the calculation unit 1001 and the selection unit 1002 may be a functional block that is realized or implemented by at least one of at least one processor and at least one memory. The at least one processor may include at least one of a CPU (Central Processing Unit), a MPU (Micro Processing Unit), a GPU (Graphic processing Unit), a FPGA (Field Programmable Gate Array), an ASIC (Application Specific Integrated Circuit), and a microcontroller, for example. The memory is a recording medium. The memory may typically be a non-transitory recording medium. As an example, the memory may include at least one of a volatile memory and a non-volatile memory. The memory may store a computer program (especially, a program code (in other words, an instruction)). The at least one processor may realize or implement at least one of the calculation unit 1001 and the selection unit 1002 by executing the program code stored in the memory. That is, at least one of the calculation unit 1001 and the selection unit 1002 may be realized or implemented on at least one processor, by that the at least one processor executes the program code stored in the memory.

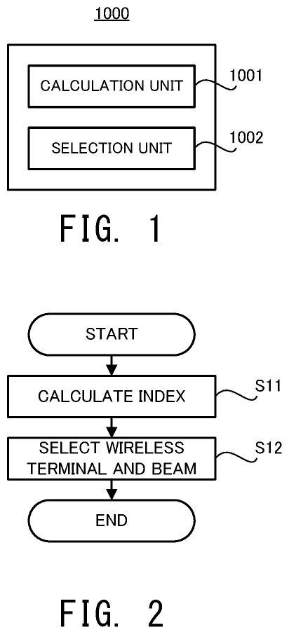

The calculation unit 1001 and the selection unit 1002 may operate in accordance with the flowchart illustrated in FIG. 2.

Specifically, as illustrated in FIG. 2, the calculation unit 1001 calculates an index indicating a relationship between the plurality of beams (step S11). The index may be an index indicating a degree of the interference between the plurality of beams. In particular, the index may be an index quantitatively indicating the degree of the interference between the plurality of beams. In particular, the calculation unit 1001 calculates the index, on the basis of a first information about a success or a failure of the communication with the plurality of wireless terminals, and a second information indicating a combination pattern of at least two of the plurality of beams used to communicate with the plurality of wireless terminals among the plurality of beams.

Then, as illustrated in FIG. 2, the selection unit 1002 selects, from among the plurality of wireless terminals and the plurality of beams, a combination of at least one wireless terminal serving as a communication target and at least one beam used to communicate with the at least one wireless terminal selected as the communication target, on the basis of the index calculated by the calculation unit 1001 (step S12).

As described above, the control apparatus 1000 in the first example embodiment selects the combination of at least one wireless terminal serving as the communication target and at least one beam used for the communication, on the basis of the index indicating the relationship between the plurality of beams. Therefore, compared with a control apparatus in a comparative example in which the combination of the wireless terminal and the beam is selected without using the index indicating the relationship between the plurality of beams, the control apparatus 1000 is allowed to select the combination of the wireless terminal and the beam so as to reduce the interference of the plurality of beams used to communicate with the plurality of wireless terminals. That is, the control apparatus 1000 is allowed to reduce the interference of the plurality of beams used to communicate with the plurality of wireless terminals.

In particular, in order to select the combination of the wireless terminal and the beam, the control apparatus 1000 in the first example embodiment does not need to estimate the positions of the plurality of wireless terminals on the assumption that the communication environment of the plurality of wireless terminals using the plurality of beams is a line-of-sight environment. Therefore, even when the communication environment of the plurality of wireless terminals using the plurality of beams is a non-line-of-sight or over-the-horizon environment, the control apparatus 1000 is allowed to reduce the interference of the plurality of beams used to communicate with the plurality of wireless terminals.

### <2> Second Example Embodiment

Next, a control apparatus, a control method, and a computer program in a second example embodiment will be described. In the following description, the control apparatus, the control method, and the computer program in the second example embodiment will be described by using a wireless communication system 1 to which the control apparatus, the control method, and the computer program in the second example embodiment are applied.

The wireless communication system 1 is a wireless communication system conforming to the technical specifications of 3GPP (Third Generation Partnership Project). For example, the wireless communication system 1 may be a wireless communication system conforming to the technical specifications of 5G. For example, the wireless communication system 1 may be a wireless communication system conforming to the technical specifications of 4G. For example, the wireless communication system 1 may be a wireless communication system conforming to the technical specifications of 3.9G. For example, the wireless communication system 1 may be a wireless communication system conforming to the technical specifications of 3G. The wireless communication system 1, however, is not limited to a wireless communication system conforming to the technical specifications of 3GPP. The wireless communication system 1 may be a wireless communication system conforming to technical specifications that are different from the technical specifications of 3GPP.

### <2-1> Overall Configuration of Wireless Communication System 1

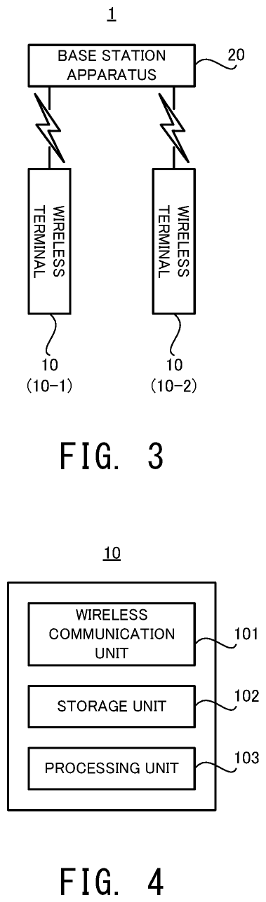

First, with reference to FIG. 3, an overall configuration of the wireless communication system 1 in the second example embodiment will be described. FIG. 3 is a block diagram illustrating the overall configuration of the wireless communication system 1 in the second example embodiment.

As illustrated in FIG. 3, the wireless communication system 1 includes a plurality of wireless terminals 10 and a base station apparatus 20. In the example illustrated in FIG. 1, the wireless communication system 1 includes two wireless terminals 10 (specifically, wireless terminals 10-1 and 10-2). The wireless communication system 1, however, may include three or more wireless terminals 10. Alternatively, the wireless communication system 1 may include a single wireless terminal 10. For convenience of explanation, the following describes an example in which the wireless communication system 1 includes two wireless terminals 10-1 and 10-2. When it is not necessary to distinguish the wireless terminals 10-1 and 10-2, each of the wireless terminals 10-1 and 10-2 is simply referred to as the wireless terminal 10.

The wireless terminal 10 is an apparatus that can be used by a user. An example of the wireless terminal 10 is at least one of a mobile phone, a smartphone, and a tablet terminal. The wireless terminal 10 may be referred to as a User Equipment (UE). The wireless terminal 10 may be referred to as a Mobile Station (MS). Furthermore, the wireless terminal 10 may have a relay function. That is, the wireless terminal 10 may function as a relay apparatus having a relay function.

The base station apparatus 20 is an apparatus that is configured to perform a wireless communication with each of the plurality of wireless terminals 10. The base station apparatus may be, for example, a node of a Radio Access Network (RAN). An example of the radio access network is at least one of a C-RAN (Centralized RAN), a D-RAN (Distributed RAN) and an O-RAN (Open RAN). An example of the base station apparatus 20 is a Base Transceiver Station (BTS) conforming to the technical specifications of 3G. An example of the base station apparatus 20 is an evolved Node B (eNodeB) conforming to at least one of the technical specifications of 3.9G, 4G and 5G. An example of the base station apparatus 20 is a next generation Node B (gNodeB) conforming to the technical specifications of 5G.

In the following description, a link used to transmit a signal from the base station apparatus 20 to the wireless terminal 10 is referred to as a “downlink”. The signal transmitted through the downlink may be referred to as a “downlink signal.” On the other hand, a link used to transmit a signal from the wireless terminal 10 to the base station apparatus 20 is referred to as an “uplink”. The signal transmitted through the uplink may be referred to as an “uplink signal.”

### <2-2> Configuration of Wireless Terminal 10

Next, a configuration of the wireless terminal 10 will be described with reference to FIG. 4. FIG. 4 is a block diagram illustrating the configuration of the wireless terminal 10.

As illustrated in FIG. 4, the wireless terminal 10 includes a wireless communication unit 101, a storage unit 102, and a processing unit 103.

The wireless communication unit 101 is an apparatus that performs a wireless communication with the base station apparatus 20. In order to perform a wireless communication with the base station apparatus 20, the wireless communication unit 101 may include an antenna and a RF (Radio Frequency) circuit, or the like, for example. The wireless communication unit 101 may transmit a radio frequency signal including the uplink signal, to the base station apparatus 20 through the uplink. The wireless communication unit 101 may receive a radio frequency signal including the downlink signal, from the base station apparatus 20 through the downlink.

The storage unit 102 is a recording medium. The storage unit 102 may be referred to as a storage apparatus. The storage unit 102 may typically be a non-transitory recording medium. As an example, the storage unit 102 may include at least one memory. For example, the storage unit 102 may include at least one of a volatile memory and a non-volatile memory, as at least one memory. The storage unit 102 may store a computer program (especially, a program code (in other words, an instruction)) for realizing each function of the wireless terminal 10.

The processing unit 103 may perform a baseband process in which a baseband signal including the uplink signal to be transmitted to the base station apparatus 20 is converted to the radio frequency signal transmitted by the wireless communication unit 101. The processing unit 103 may perform a baseband process in which the radio frequency signal received by the wireless communication unit 101 is converted to a baseband signal including the downlink signal received from the base station apparatus 20.

The processing unit 103 may include at least one processor. For example, the processing unit 103 may include, as at least one processor, at least one of a CPU (Central Processing Unit), a MPU (Micro Processing Unit), a GPU (Graphic processing Unit), a FPGA (Field Programmable Gate Array), an ASIC (Application Specific Integrated Circuit), and a microcontroller. At least one processor provided by the processing unit 103 may realize or implement a functional block for performing a process to be performed by the processing unit 103 (e.g., the baseband process described above) by executing the program code stored in the storage unit 102. That is, the functional block for performing the process to be performed by the processing unit 103 (e.g., the baseband process described above) may be realized or implemented on at least one processor provided by the processing unit 103.

### <2-3> Configuration of Base Station Apparatus 20

Next, a configuration of the base station apparatus 20 will be described.

### <2-3-1> Overall Configuration of Base Station Apparatus 20

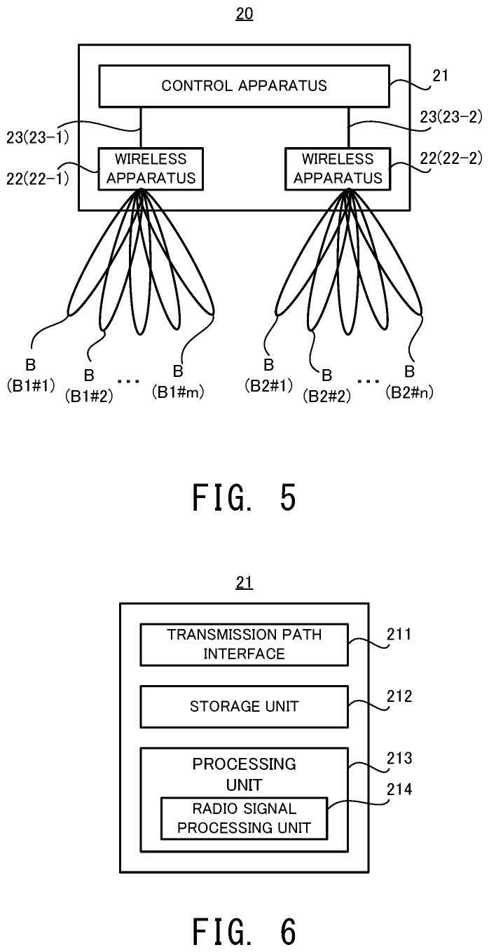

First, with reference to FIG. 5, an overall configuration of the base station apparatus 20 will be described. FIG. 5 is a block diagram illustrating the overall configuration of the base station apparatus 20.

As illustrated in FIG. 5, the base station apparatus 20 includes a control apparatus 21 and a plurality of wireless apparatuses 22. In the example illustrated in FIG. 5, the base station apparatus 20 includes two wireless apparatuses 22 (specifically, wireless apparatuses 22-1 and 22-2). The base station apparatus 20, however, may include three or more wireless apparatuses 22. Alternatively, the base station apparatus 20 may include a single wireless apparatus 22. For convenience of explanation, the following describes an example in which the base station apparatus 20 includes two wireless apparatuses 22-1 and 22-2. In the following description, when it is not necessary to distinguish the wireless apparatuses 22-1 and 22-2, each of the wireless apparatuses 22-1 and 22-2 is simply referred to as the wireless apparatus 22.

The control apparatus 21 is an apparatus that is configured to control a communication between the plurality of wireless terminals 10 and the base station apparatus 20. The control apparatus 21 may be, for example, a Central Unit or Centralized Unit (CU). In other words, the control apparatus 21 may function as a Central Unit. The control apparatus 21 may be, for example, a Distributed Unit (DU). In other words, the control apparatus 21 may function as a Distributed Unit. In this case, the control apparatus 21 may be referred to as a master station. The control apparatus 21, however, may include at least a part of the functions of an antenna unit or a Radio Unit or Remote Unit (Ru) that may be referred to as a slave station, for example.

The wireless apparatus 22 is an apparatus that is configured to perform a wireless communication with at least one of the plurality of wireless terminals 10, under the control of the control apparatus 21. Specifically, the wireless apparatus 22 is configured to perform a wireless communication with at least one of the plurality of wireless terminals 10, by using a beam (i.e., a radio wave) B. For example, the wireless apparatus 22 may transmit the radio frequency signal including the downlink signal, to at least one of the plurality of wireless terminals 10 by using the beam B. The wireless apparatus 22 may receive the radio frequency signal including the uplink signal, from at least one of the plurality of wireless terminals 10 by using the beam B.

The wireless apparatus 22 may be an antenna unit or a Radio Unit or Remote Unit (RU), for example. In other words, the wireless apparatus 22 may function as an antenna unit or a remote unit. The wireless apparatus 22 may be a Transmission and Reception Point (TRP), for example. In other words, the wireless apparatus 22 may function as a Transmission and Reception Point. The wireless apparatus 22 may be an Access Point (AP), for example. In other words, the wireless apparatus 22 may function as an access point. When the base station apparatus 20 includes a plurality of wireless apparatuses 22, the base station apparatus 20 may function as Distributed Antenna Systems (DAS). The wireless apparatus 22 may include a part of the functions of the antenna unit or the remote unit, but may not include another part of the functions of the antenna unit or the remote unit.

At least one of the plurality of wireless apparatuses 22 may be disposed at a position that is physically far from that of the control apparatus 21. In this case, the control apparatus 21 is connected to the wireless apparatus 22 through a transmission path 23 that is a medium used for information transmission. An example of the transmission path 23 is at least one of an optical fiber, a metal cable, and a wireless propagation path. In the example illustrated in FIG. 5, the control apparatus 21 is connected to the wireless apparatus 22-1 through a transmission path 23-1, and is connected to the wireless apparatus 22-2 through a transmission path 23-2. The control apparatus 21 communicates with the wireless apparatus 22-1 through the transmission path 23-1. The control apparatus 21 communicates with the wireless apparatus 22-2 through the transmission path 23-2. In this case, the control apparatus 21 communicates with the plurality of wireless terminals 10-1 and 10-2 through the plurality of wireless apparatuses 22-1 and 22-2.

A RoF (Radio over Fiber) technique/technology may be applied to the communication between the control apparatus 21 and the wireless apparatus 22. A CPRI (Common Public Radio Interface) technique/technology may be applied to the communication between the control apparatus 21 and the wireless apparatus 22. An eCPRI (evolved Common Public Radio Interface) technique/technology may be applied to the communication between the control apparatus 21 and the wireless apparatus 22.

The wireless apparatus 22 performs beamforming. The beamforming is a technique/technology of controlling at least one of a shape and a direction (in other words, angle) of the beam B used for the wireless communication of the wireless apparatus 22 with the wireless terminal 10. The wireless apparatus 22 is configured to form a plurality of beams B in which at least one of the shape and the direction is different, by performing the beamforming. In this case, the wireless apparatus 22 may communicate wirelessly with the wireless terminal 10 by using at least one of the plurality of beams B. In the example illustrated in FIG. 5, the wireless apparatus 22-1 is configured to form m beams B (specifically, beams B1#1, B1#2, . . . , and B1#m) (wherein m is a variable indicating an integer of 2 or more) in which at least one of the shape and the direction is different, by performing the beamforming. Furthermore, in the example illustrated in FIG. 5, the wireless apparatus 22-2 is configured to form n beams B (specifically, beams B2#1, B2#2, . . . , and B2#n) (wherein n is a variable indicating an integer of 2 or more) in which at least one of the shape and the direction is different, by performing the beamforming. The wireless apparatus 22, however, may not perform the beamforming.

The plurality of beams B may be distinguished from each other by a beam number thereof. The beam number is an identifier assigned in advance to a combination of the shape and the direction of the beam B. In the example illustrated in FIG. 5, the wireless apparatus 22-1 is configured to form them beams B to which m beam numbers of “1#1”, “1#2”, . . . , and “1#m” are assigned, respectively. Furthermore, in the example illustrated in FIG. 5, the wireless apparatus 22-2 is configured to form then beams B to which n beam numbers of “2#1”, “2#2”, . . . , and “2#n” are assigned, respectively.

### <2-3-2> Configuration of Control Apparatus 21

Next, with reference to FIG. 6, a configuration of the control apparatus 21 provided by the base station apparatus 20 will be described. FIG. 6 is a block diagram illustrating the configuration of the control apparatus 21.

As illustrated in FIG. 6, the control apparatus 21 includes a transmission path interface 211, a storage unit 212, and a processing unit 213.

The transmission path interface 211 is an interface for communicating with the wireless apparatus 22 through the transmission path 23.

The storage unit 212 is a recording medium. The storage unit 212 may be referred to as a storage apparatus. The storage unit 212 may typically be a non-transitory recording medium. As an example, the storage unit 212 may include at least one memory. The storage unit 212 may include at least one of a volatile memory and a non-volatile memory, as at least one memory. The storage unit 212 may store a computer program (especially, a program code (in other words, an instruction)) for realizing each function of the control apparatus 21.

The processing unit 213 performs a signal process for communicating with the plurality of wireless terminals 10 through the plurality of wireless apparatuses 22.

The processing unit 213 may include at least one processor. For example, the processing unit 213 may include, as at least one processor, at least one of a CPU (Central Processing Unit), a MPU a (Micro Processing Unit), a GPU (Graphic processing Unit), a FPGA (Field Programmable Gate Array), an ASIC (Application Specific Integrated Circuit), and a microcontroller. At least one processor provided by the processing unit 213 may realize or implement a functional block for performing a process to be performed by the processing unit 213 (e.g., the signal process described above) by executing the program code stored in the storage unit 212. That is, the functional block for performing the process to be performed by the processing unit 213 (e.g., the signal process described above) may be realized or implemented on at least one processor provided by the processing unit 213.

As illustrated in FIG. 6, the processing unit 213 includes a radio signal processing unit 214, as an example of the functional block for performing the process to be performed by the processing unit 213 (e.g., the signal process described above). As at least a part of the signal process, the radio signal processing unit 214 performs a transmission process of transmitting the downlink signal to be transmitted from the base station apparatus 20 to the wireless terminal 10, and a reception process of receiving the uplink signal received by the base station apparatus 20 from the wireless terminal 10.

In addition to or in place of the control apparatus 21, the wireless apparatus 22 may be provided with a part of the function of the radio signal processing unit 214. In addition to or in place of the control apparatus 21, another not-illustrated apparatus that is physically far from the control apparatus 21 may be provided with a part for the function of the radio signal processing unit 214.

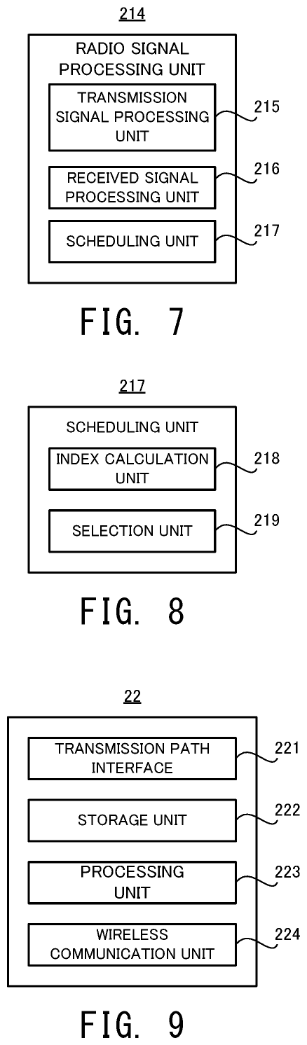

An example of a configuration of the radio signal processing unit 214 that performs the transmitting process and the reception process is illustrated in FIG. 7. As illustrated in FIG. 7, the radio signal processing unit 214 includes a transmission signal processing unit 215, a received signal processing unit 216, and a scheduling unit 217 as functional blocks for performing the process to be performed by the processing unit 213 (e.g., the signal process described above).

The transmission signal processing unit 215 performs a transmission process of transmitting the downlink signal to be transmitted from the base station apparatus 20 to the wireless terminal 10. The downlink signal to be transmitted from the base station apparatus 20 to the wireless terminal 10 may be referred to as a transmission signal. For example, the transmission signal processing unit 215 may generate the downlink signal to be transmitted to the wireless terminal 10. As an example, the transmit signal processing unit 215 may generate a baseband signal including the downlink signal. Furthermore, the transmission signal processing unit 215 may transmit the generated downlink signal (baseband signal) to the wireless apparatus 22 through the transmission path interface 211 and the transmission path 23.

The received signal processing unit 216 performs a reception process of receiving the uplink signal received by the base station apparatus 20 from the wireless terminal 10. For example, the received signal processing unit 216 receives the uplink signal received by the wireless apparatus 22, through the transmission path interface 211 and the transmission path 23. As an example, the received signal processing unit 216 may receive a baseband signal including the uplink signal, which is generated by demodulating the radio frequency signal received by the wireless apparatus 22. Furthermore, the received signal processing unit 216 may perform a decoding process, an error correction process or the like, on the uplink signal (baseband signal).

Especially in the second example embodiment, the received signal processing unit 216 obtains a communication success/failure information about the success/failure of the communication between the base station apparatus 20 and the wireless terminal 10. The received signal processing unit 216 transmits the obtained communication success/failure information to the scheduling unit 217.

The scheduling unit 217 allocates radio resources used to communicate with the wireless terminal 10. The radio resource may include at least one of the wireless terminal 10 serving as the communication target, an antenna, the beam B, frequency and time, and the like. The scheduling unit 217 transmits a result of the allocation of the radio resources, to the transmission signal processing unit 215 and the received signal processing unit 216. The transmission signal processing unit 215 may control the wireless apparatus 22 to transmit the downlink signal to the wireless terminal 10, by using the radio resource allocated by the scheduling unit 217. For example, the transmission signal processing unit 215 may control the beam B used by the wireless apparatus 22 to transmit the downlink signal to the wireless terminal 10, on the basis of the radio resource allocated by the scheduling unit 217. Furthermore, the received signal processing unit 216 may control the wireless apparatus 22 to receive the uplink signal from the wireless terminal 10, by using the radio resource allocated by the scheduling unit 217. For example, the received signal processing unit 216 may control the beam B used by the wireless apparatus 22 to receive the uplink signal from the wireless terminal 10, on the basis of the radio resource allocated by the scheduling unit 217.

Alternatively, the scheduling unit 217 may transmit the result of the allocation of the radio resources to the wireless apparatus 22 through the transmission path 23. In this case, the wireless apparatus 22 may transmit the downlink signal to the wireless terminal 10 by using the radio resource allocated by the scheduling unit 217. For example, the wireless apparatus 22 (e.g., at least one of a wireless communication unit 224 and a processing unit 223 described later) may control the beam B used by the wireless apparatus 22 to transmit the downlink signal to the wireless terminal 10, on the basis of the radio resource allocated by the scheduling unit 217. Furthermore, the wireless apparatus 22 may receive the uplink signal from the wireless terminal 10, by using the radio resource allocated by the scheduling unit 217. For example, the wireless apparatus 22 (e.g., at least one of the wireless communication unit 224 and processing unit 223 described later) may control the beam B used by the wireless apparatus 22 to receive the uplink signal from the wireless terminal 10, on the basis of the radio resource allocated by the scheduling unit 217.

Especially in the second example embodiment, the scheduling unit 217 includes an index calculation unit 218 and a selection unit 219 as functional blocks as illustrated in FIG. 8 that illustrates a configuration of the scheduling unit 217. The scheduling unit 217 may allocate, as the radio resources, the wireless terminal 10 serving as the communication target of the wireless apparatus 22 and the beams B, by using the index calculation unit 218 and the selection unit 219. That is, the scheduling unit 217 may select, from among the plurality of wireless terminals 10 and the plurality of beams B, a combination of at least two wireless terminals 10 serving as the communication targets and at least two beams B used respectively to communicate with the at least two wireless terminals 10.

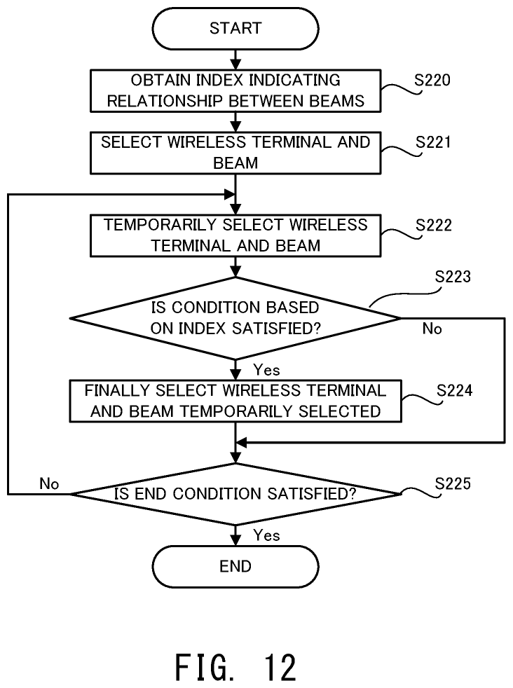

The operation of selecting the combination of the wireless terminal 10 and the beam B by using the index calculation unit 218 and the selection unit 219 will be described later in detail with reference to FIG. 10 and the like. An outline thereof will be briefly described below.

The index calculation unit 218 obtains the communication success/failure information about the success/failure of the communication between the base station apparatus 20 and the wireless terminal 10. Furthermore, the index calculation unit 218 obtains a beam information about the combination (in other words, the allocation) of the beams B used when the communication whose success/failure is indicated by the communication information is performed. The index calculation unit 218 calculates an index X indicating a relationship between the plurality of beams B that can be used by the base station apparatus 20, on the basis of the communication success/failure information and the beam information. The details of the index X will be described in detail later and a description there of is omitted here. The selection unit 219 selects the combination of the wireless terminal 10 and the beam B on the basis of the index X calculated by the index calculation unit 218.

### <2-3-3> Configuration of Wireless Apparatus 22

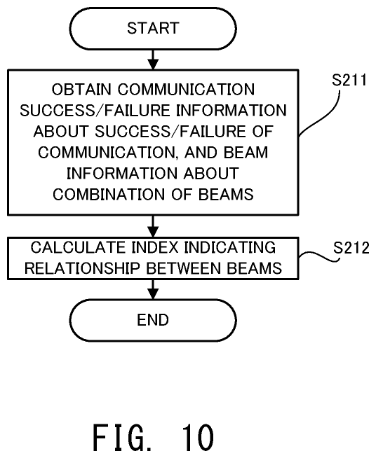

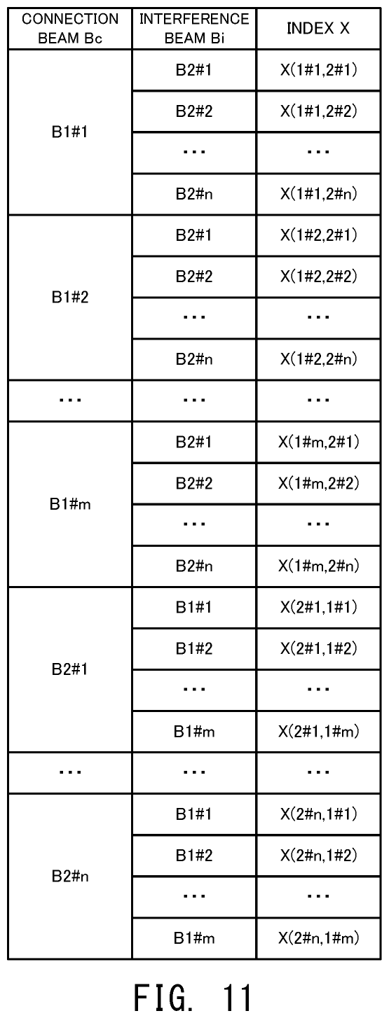

Next, with reference to FIG. 9, a configuration of the wireless apparatus 22 provided by the base station apparatus 20 will be described. FIG. 9 is a block diagram illustrating the configuration of the wireless apparatus 22.

As illustrated in FIG. 9, the wireless apparatus 22 includes a transmission path interface 221, a storage unit 222, a processing unit 223, and a wireless communication unit 224.

The transmission path interface 221 is an interface for communicating with the control apparatus 21 through the transmission path 23.

The storage unit 222 is a recording medium. The storage unit 222 may be referred to as a storage apparatus. The storage unit 222 may typically be a non-transitory recording medium. As an example, the storage unit 222 may include at least one memory. The storage unit 222 may include at least one of a volatile memory and a non-volatile memory, as at least one memory. The storage unit 222 may store a computer program (especially, a program code (in other words, an instruction)) for realizing each function of the wireless apparatus 22.

The processing unit 223 may perform a baseband process in which the baseband signal (transmission signal) transmitted from the control apparatus 21 through the transmission path 23 is converted to a radio frequency signal (downlink signal) transmitted by the wireless communication unit 224. The processing unit 223 may perform a baseband process in which a radio frequency signal (uplink signal) received by the wireless communication unit 224 is converted to the baseband signal.

When the wireless apparatus 22 performs the beamforming as described above, the processing unit 223 may perform the beamforming. That is, the processing unit 223 may control at least one of the shape and the direction (angle) of the beam B formed by an antenna provided by the wireless communication unit 224. Specifically, the processing unit 223 may control at least one of the shape and the direction (angle) of the beams B, by adjusting at least one of the amplitude and the phase of the radio frequency signal. Alternatively, the processing unit 223 may control at least one of the shape and the direction (angle) of the beams B, by performing a process for adjusting at least one of the amplitude and the phase of the radio frequency signal, on the baseband signal. In this case, the control apparatus 21 may determine a command value of at least one of the amplitude and the phase of the radio frequency signal, and may notify the processing unit 223 of the determined command value. The processing unit 223 may control at least one of the amplitude and the phase of the radio frequency signal such that at least one of the amplitude and the phase of the radio frequency signal matches the command value.

The processing unit 223 may include at least one processor. For example, the processing unit 223 may include, as at least one processor, at least one of a CPU (Central Processing Unit), a MPU (Micro Processing Unit), a GPU (Graphic processing Unit), a FPGA (Field Programmable Gate Array), an ASIC (Application Specific Integrated Circuit), and a microcontroller. At least one processor provided by the processing unit 223 may realize or implement a functional block for performing a process to be performed by the processing unit 223 (e.g., the baseband process described above) by executing a program code stored in the storage unit 222. That is, the functional block for performing the process to be performed by the processing unit 223 (e.g., the baseband process described above) may be realized or implemented on at least one processor of the processing unit 223.

The wireless communication unit 224 is an apparatus that performs a wireless communication with the wireless terminal 10. In order to perform a wireless communication with the wireless terminal 10, the wireless communication unit 224 may include, for example, an antenna and RF (Radio Frequency) circuit, or the like. The wireless communication unit 224 may transmit a radio frequency signal (downlink signal) to the wireless terminal 10 through the downlink. The wireless communication unit 224 may receive a radio frequency signal (uplink signal) transmitted from the wireless terminal 10 through the uplink.

When the wireless apparatus 22 performs the beamforming as described above, the wireless communication unit 224 may include a plurality of antennas that are respectively configured to form a plurality of beams B in which at least one of the shape and the direction is different. Each of the plurality of antennas may be a directional antenna. An example of the directional antenna is at least one of a lens antenna and a metamaterial. Alternatively, the wireless communication unit 224 may include a single antenna that is configured to control at least one of the shape and the direction of the beam B.

### <2-4> Operation of Selecting Combination of Wireless Terminal 10 and Beam B

Next, the operation of selecting the combination of the wireless terminal 10 and the beam B by using the scheduling unit 217 (especially, the index calculation unit 218 and the selection unit 219) will be described. The operation of selecting the combination of the wireless terminal and the beam B includes, as described above, an operation of calculating the index X by using the index calculation unit 218 (hereinafter referred to as an “index calculation operation”) and an operation of selecting the combination of the wireless terminal 10 and the beam B on the basis of the index X by using the selection unit 219 (hereinafter referred to as a “combination selection operation”). Therefore, in the following description, the index calculation operation and the combination selection operation will be described in order.

In the following description, processing steps illustrated in the flowchart may not necessarily be performed in the order illustrated. The processing steps may be performed in different order from that illustrated order. Two or more processing steps may be performed in parallel. In addition, a part of the processing steps may be removed. Not-illustrated processing steps may be further added.

### <2-4-1> Index Calculation Operation

First, with reference to FIG. 10, the index calculation operation of calculating the index X will be described. FIG. 10 is a flowchart illustrating a flow of the index calculation operation of calculating the index X.

As illustrated in FIG. 10, in order to calculate the index X, the index calculation unit 218 obtains the communication success/failure information about the success/failure of the communication between the wireless terminal 10 and the base station apparatus 20 (step S211). An example of the operation in which the index calculation unit 218 obtains the communication success/failure information will be described below. The index calculation unit 218, however, may obtain the communication success/failure information by performing a different operation from the operation described below.

First, the index calculation unit 218 may control the wireless apparatus 22 to perform a test communication for obtaining the communication success/failure information, by using the radio signal processing unit 214. Specifically, the radio signal processing unit 214 may control the wireless apparatus 22 such that the wireless apparatus 22 communicates with the wireless terminal 10 by using each of the plurality of beams B. For example, the radio signal processing unit 214 may control the wireless apparatus 22-1 such that the wireless apparatus 22-1 communicates with the wireless terminal 10 by using each of them beams B1#1 to B1#m. That is, the radio signal processing unit 214 may control the wireless apparatus 22-1 such that the wireless apparatus 22-1 sequentially transmits the beams B1#1 to B1#m to communicate with the wireless terminal 10. For example, the radio signal processing unit 214 may control the wireless apparatus 22-2 such that the wireless apparatus 22-2 communicates with the wireless terminal 10 by using each of the n beams B2#1 to B2#n. That is, the radio signal processing unit 214 may control the wireless apparatus 22-2 such that the wireless apparatus 22-2 sequentially transmits the n beams B2#1 to B2#n to communicate with the wireless terminal 10.

In this case, the radio signal processing unit 214 may repeat a test scan operation of controlling the wireless apparatuses 22-1 and 22-2 such that the wireless apparatus 22-1 communicates with the wireless terminal 10 disposed in the coverage area of the wireless apparatus 22-1 by using a beam B1#p (wherein p is a variable indicating an integer that is greater than or equal to 1 and is less than or equal to m) and such that, at the same time, the wireless apparatus 22-2 communicates with the wireless terminal 10 disposed in the coverage area of the wireless apparatus 22-1 by using a beam B2#q (wherein q is a variable indicating an integer that is greater than or equal to 1 and is less than or equal to n), while changing a combination of the variable p and the variable q. Typically, the radio signal processing unit 214 may perform the test scan operation on all candidates for the combination of the variable p and the variable q.

While operating the test scanning operation, the radio signal processing unit 214 (especially, the received signal processing unit 216) may obtain, as the communication success/failure information, a downlink information about the success/failure of the communication through the downlink. The downlink information may include, for example, ACK (Acknowledgement) contained in the downlink signal. For example, the downlink information may include ACK for the signal transmitted from the wireless apparatus 22-1 to the wireless terminal 10 by using each of the m beams B1#1 to B1#m. For example, the downlink information may include ACK for the signal transmitted from the wireless apparatus 22-2 to the wireless terminal 10 by using each of the n beams B2#1 to B2#n. Alternatively, the downlink information may include, for example, NACK (Negative Acknowledgement) contained in the downlink signaling, in addition to or in place of the ACK. For example, the downlink information may include NACK for the signal transmitted from the wireless apparatus 22-1 to the wireless terminal 10 by using each of the m beams B1#1 to B1#m. For example, the downlink information may include NACK for the signal transmitted from the wireless apparatus 22-2 to the wireless terminal 10 by using each of the n beams B2#1 to B2#n.

In addition, while operating the test scanning operation, the radio signal processing unit 214 (especially, the received signal processing unit 216) may obtain, as the communication success/failure information, an uplink information about the success/failure of the communication through the uplink, in addition to or in place of the downlink information. In order to obtain the uplink information, the received signaling processing unit 216 may determine the success/failure of the communication through the uplink. For example, the received signal processing unit 216 may request the wireless terminal 10 to transmit the uplink signal by using each of the plurality of beams B, and may determine the success/failure of the communication through the uplink on the basis of the presence or absence of a response to the request from the wireless terminal 10. As an example, the received signal processing unit 216 may request the wireless terminal 10 to transmit the uplink signal, and may determine the success/failure of the communication through the uplink on the basis of whether or not the uplink signal transmitted in response to the request is received.

The received signal processing unit 216 transmits the obtained communication success/failure information to the scheduling unit 217 (especially, the index calculation unit 218). As a result, the index calculation unit 218 is allowed to obtain the communication success/failure information.

The index calculation unit 218 further obtains the beam information about the combination of the beams B used by the base station apparatus 20 to obtain the information about the success/failure of the communication between the wireless terminal 10 and the base station apparatus 20 (step S211). The beam information may include, for example, information about the combination of the variable p and the variable q described above. The beam information may be stored in the storage unit 212, for example.

Then, the index calculation unit 218 calculates the index X indicating the relationship between the plurality of beams B, on the basis of the communication success/failure information and the beam information obtained in the step S211 (step S212).

In the second example embodiment, the index calculation unit 218 may calculate, as the index X indicating the relationship between the plurality of beams B, the index X indicating the relationship between the m beams B1#1 to B1#m and the n beams B2#1 to B2#n. That is, the index calculation unit 218 may calculate, as the index X indicating the relationship between the plurality of beams B, the index X indicating the relationship between the beam B1#p and the beam B2#q. For example, the index calculation unit 218 may calculate at least one of the following: an index X indicating the relationship between the beam B1#1 and the beam B2#1, an index X indicating the relationship between the beam B1#1 and the beam B2#2, and so on, an index X indicating the relationship between the beam B1#1 and the beam B2#n, an index X indicating the relationship between the beam B1#2 and the beam B2#1, an index X indicating the relationship between the beam B1#2 and the beam B2#2, and so on, an index X indicating the relationship between the beam B1#2 and the beam B2#n, and so on, an index X indicating the relationship between the beam B1#m and the beam B2#1, an index X indicating the relationship between the beam B1#m and the beam B2#2, and so on, and an index X indicating the relationship between the beam B1#m and the beam B2#n.

The index calculation unit 218 may calculate, as the index X indicating the relationship between the beam B1#p and the beam B2#q, the index X indicating the relationship between the beam B1#p and the beam B2#q in the situation where the beam B1#p is a connection beam Bc and the beam B2#q is an interference beam Bi. The index calculation unit 218 may calculate, as the index X indicating the relationship between the beam B1#p and the beam B2#q, the index X indicating the relationship between the beam B1#p and the beam B2#q in the situation where the beam B2#q is the connection beam Bc and the beam B1#p is the interference beam Bi. The connection beam Bc is the beam B used for the communication between one wireless terminal 10 and the base station apparatus 20. On the other hand, the interference beam Bi is the beam B that interferes with the connection beam Bc. That is, in the situation where the communication is performed between one wireless terminal 10 and the base station apparatus 20 by using the connection beam Bc, the interference beam Bi is the beam B that is used for the communication between another wireless terminal 10 that is different from the one wireless terminal 10 and the base station apparatus 20, and that interferes with the beam B (i.e., connection beam Bc) used by the one wireless terminal 10.

An example of the index X calculated by the index calculation unit 218 is illustrated in FIG. 11. As illustrated in FIG. 11, the index calculation unit 218 may calculate at least one of the following: an index X(1#1, 2#1) indicating the relationship between the beam B1#1 and the beam B2#1 in the situation where the beam B1#1 is the connection beam Bc and the beam B2#1 is the interference beam Bi, an index X(1#1, 2#2) indicating the relationship between the beam B1#1 and the beam B2#2 in the situation where the beam B1#1 is the connection beam Bc and the beam B2#2 is the interference beam Bi, and so on, an index X(1#1, 2#n) indicating the relationship between the beam B1#1 and the beam B2#n in the situation where the beam B1#1 is the connection beam Bc and the beam B2#n is the interference beam Bi, an index X(1#2, 2#1) indicating the relationship between the beam B1#2 and the beam B2#1 in the situation where the beam B1#2 is the connection beam Bc and the beam B2#1 is the interference beam B1, an index X(1#2, 2#2) indicating the relationship between the beam B1#2 and the beam B2#2 in the situation where the beam B1#2 is the connection beam Bc and the beam B2#2 is the interference beam Bi, and so on, an index X(1#2, 2#n) indicating the relationship between the beam B1#2 and the beam B2#n in the situation where the beam B1#2 is the connection beam Bc and the beam B2#n is the interference beam Bi, and so on, an index X(1#m, 2#1) indicating the relationship between the beam B1#m and the beam B2#1 in the situation where the beam B1#m is the connection beam Bc and the beam B2#1 is the interference beam Bi, an index X(1#m, 2#2) indicating the relationship between the beam B1#m and the beam B2#2 in the situation where the beam B1#m is the connection beam Bc and the beam B2#2 is the interference beam Bi, and so on, and an index X(1#m, 2#n) indicating the relationship between the beam B1#m and the beam B2#n in the situation where the beam B1#m is the connection beam Bc and the beam B2#n is the interference beam Bi.

The index X may indicate a degree of the interference between the plurality of beams B. For example, the index X may indicate a degree of the interference between the connection beam Bc and the interference beam Bi. For example, the index X may indicate a degree of the interference of the interference beam Bi with respect to the connection beam Bc. For example, the index X may indicate a degree of the interference of the communication using the interference beam Bi with respect to the communication using the connection beam Bc. In particular, the index X may quantitatively indicate the degree of the interference between the plurality of beams B. For example, the index X may quantitatively indicate the degree of the interference between the connection beam Bc and the interference beam Bi. For example, the index X may quantitatively indicate the degree of the interference of the interference beam Bi with respect to the connection beam Bc. An example of the degree of the interference is the amount of interference.

In this case, as the degree of the interference between the connection beam Bc and the interference beam Bi increases, it is more likely that the communication using the connection beam Bc is failed. Therefore, the index calculation unit 218 may calculate the index X so as to increase the index X corresponding to the combination of the connection beam Bc and the interference beam Bi, with a worse success/failure result of the communication using the connection beam Bc indicated by the communication success/failure information. The index calculation unit 218 may calculate the index X so as to reduce the index X corresponding to the combination of the connection beam Bc and the interference beam Bi, with a better success/failure result of the communication using the connection beam Bc indicated by the communication success/failure information.

An example of the index X indicating the degree of the interference between the connection beam Bc and the interference beam Bi is an error rate. An example of the error rate includes at least one of a Block Error Rate (BLER), a Bit Error Rate (BER), and a Packet Error Rate (PER) that can be calculated from the downlink information (e.g., Ack or Nack) described above. In this case, the index calculation unit 218 may calculate the error rate (especially, the error rate in the downlink) as the index X, on the basis of the downlink signal.

For convenience of explanation, the following describes an example in which the error rate calculated from the downlink information is used as the index X. In this case, with a worse success/failure result of the communication using the connection beam Bc indicated by the communication success/failure information, the index X (i.e., error rate) corresponding to the combination of the connection beam Bc and the interference beam Bi increases.

The index calculation unit 218 may calculate the error rate (especially, the error rate in the uplink) as the index X, on the basis of the uplink information, in addition to or in place of the downlink information. Even in this case, the index calculation unit 218 may calculate at least one of the block error rate, the bit error rate, and the packet error rate, as the index X, on the basis of the uplink information.

The index calculation unit 218 may separately calculate the index X in the downlink and the index X in the uplink. Alternatively, the index calculation unit 218 may calculate the index X common to the downlink and the uplink, without distinguishing between the downlink and the uplink. The index X common to the downlink and the uplink may be the index X obtained by an arithmetic operation using the index X in the downlink and the index X in the uplink. As an example, the index X common to the downlink and the uplink may be the sum or average of the index X in the downlink and the index X in the uplink. Alternatively, the index calculation unit 218 may calculate one of the index X in the downlink and the index X in the uplink, and may not calculate the other of the index X in the downlink and the index X in the uplink.

The index calculation unit 218 may estimate a degree of the interference between the beam B1#p and the beam B2#q, in addition to or in place of the communication success/failure information, and may calculate the index X indicating the relationship between the beam B1#p and the beam B2#q on the basis of an estimation result of the degree of the interference. For example, the degree of the interference between the beam B1#p and the beam B2#q may be estimated on the basis of the respective directions of the beam B1#p and the beam B2#q. As an example, when the direction of the beam B1#p is opposite to a direction in which the wireless apparatus 22-2 exists, and when the direction of the beam B2#q is opposite to a direction in which the wireless apparatus 22-1 exists, the index calculation unit 218 may estimate that the degree of the interference between the beam B1#p and the beam B2#q is zero (i.e., the amount of interference is zero). That is, when the beam B1#p is transmitted from the wireless apparatus 22-1 in an opposite direction to the direction in which the wireless apparatus 22-2 exists, and when the beam B2#q is transmitted from the wireless apparatus 22-2 in an opposite direction to the direction in which the wireless apparatus 22-1 exists, the index calculation unit 218 may estimate that the degree of the interference between the beam B1#p and the beam B2#q is zero (i.e., the amount of interference is zero). In this case, without calculating the index X indicating the relationship between the beam B1#p and the beam B2#q by using the communication success/failure information, the index calculation unit 218 may set the index X (e.g., error rate) to zero.

The index calculation unit 218 may sequentially calculate the index X at each time that the communication success/failure information and the beam information are obtained. Alternatively, the index calculation unit 218 accumulates the obtained communication success/failure information and beam information, and may collectively calculate a plurality of indices X by using the accumulated communication success/failure information and beam information. In the situation where the index X indicating the relationship between the beam B1#p and the beam B2#q is already calculated, when the beam information and the success/failure information about the success/failure of the communication using the same beam B1#p and the same beam B2#q are obtained, the index calculation unit 218 may update the calculated index X by newly calculating the index X.

### <2-4-2> Combination Selection Operation

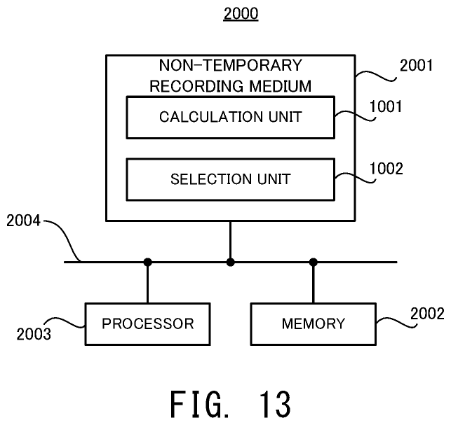

Next, with reference to FIG. 12, the combination selection operation of selecting the combination of the wireless terminal 10 and the beam B on the basis of the index X calculated by the index calculation operation will be described. FIG. 12 is a flowchart illustrating a flow of the combination selection operation of selecting the combination of the wireless terminal 10 and the beam B on the basis of the index X.

As illustrated in FIG. 12, the selection unit 219 obtains the index X from the index calculation unit 218 (step S220). Alternatively, when the index calculation unit 218 stores the calculated index X in the storage unit 212, the selection unit 219 may obtain the index X from the storage unit 212.

In parallel with or before and after the step S220, the selection unit 219 selects, from among the plurality of wireless terminals 10 and the plurality of beams B, the combination of one wireless terminal 10 serving as the communication target of the base station apparatus 20 and one beam B used to communicate with the one wireless terminal 10 (step S221). The following describes an example in which the selection unit 219 selects the combination of the wireless terminal 10 serving as the communication target of the wireless apparatus 22-1 and the beam B used by the wireless apparatus 22-1 to communicate with the wireless terminal 10, in the step S221. Especially, the following describes an example in which the selection unit 219 selects a beam B1#1 (wherein i is a variable indicating an integer that is greater than or equal to 1 and is less than or equal to m), as the beam B to be used by the wireless apparatus 22-1, in the step S221.

In the step S221, the selection unit 219 may select the combination of the wireless terminal 10 and the beam B by using existing terminal selection methods and existing beam selection methods. For example, in the step S221, the selection unit 219 may select the combination of the wireless terminal 10 and the beam B by using the terminal selection method and the beam selection method described in at least one of Patent Literatures 1 to 4. As an example, in the step S221, the selection unit 219 may select the combination of the wireless terminals 10 and the beam B in which the received power from the wireless apparatus 22-1 is maximized or is greater than a predetermined power threshold.

Then, the selection unit 219 temporarily selects, from among the plurality of wireless terminals 10 and the plurality of beams B, a combination of a new wireless terminal 10 serving as the communication target of the base station apparatus 20 and a new beam B used to communicate with the new wireless terminal 10 (step S222). As described above, since the wireless terminal 10 serving as the communication target of the wireless apparatus 22-1 is selected in the step S221, the selection unit 219 temporarily selects the combination of the wireless terminal 10 serving as the communication target of the wireless apparatus 22-2 and the beam B used by the wireless apparatus 22-2 to communicate with the wireless terminal 10 in the step S222. The following describes an example in which the selection unit 219 temporarily selects a beam B2#j (wherein j is a variable indicating an integer that is greater than or equal to 1 and is less than or equal to n), as the beam B used by the wireless apparatus 22-2, in the step S222.

Even in the step S222, similarly to the step S221, the selection unit 219 may temporarily select the combination of the wireless terminal 10 and the beam B by using the existing terminal selection methods and the existing beam selection methods. For example, in the step S222, selection unit 219 may select the combination of the wireless terminal 10 and the beam B by using the terminal selection method and the beam selection method described in at least one of Patent Literatures 1 to 4. As an example, in the step S222, the selection unit 219 may select the combination of the wireless terminals 10 and the beam B in which the received power from the wireless apparatus 22-2 is maximized or is greater than a predetermined power threshold. In the step S222, however, the selection unit 219 does not select the already selected wireless terminals and beams B.

Then, the selection unit 219 determines whether or not a predetermined selection condition based on the index X is satisfied (step S223). An example of the predetermined selection condition based on the index X is such a condition that the index X (e.g., error rate) corresponding to the combination of the beam B selected in the step S221 and the beam B selected in the step S222 is less than a predetermined threshold.

Specifically, as described above, the beam B1#i is selected in the step S221, and the beam B2#j is selected in the step S222. In this case, the selection condition may include such a condition that the index X corresponding to the combination of the beam B1#i and the beam B2#j is less than a predetermined threshold.

As described above, the index X corresponding to the combination of the beam B1#i and the beam B2#j includes an index X(1#i, 2#j) indicating the relationship between the beam B1#i and the beam B2#j in the situation where the beam B1#i is the connection beam Bc and the beam B2#j is the interference beam Bi. Therefore, the selection condition may include such a condition that the index X(1#i, 2#j) is less than a predetermined threshold.

As described above, the index X corresponding to the combination of the beam B1#i and the beam B2#j includes an index X(2#j, 1#i) indicating the relationship between the beam B1#i and the beam B2#j in the situation where the beam B2#j is the connection beam Bc and the beam B1#i is the interference beam Bi. Therefore, the selection condition may include such a condition that the index X(2#j, 1#i) is less than a predetermined threshold.

The following describes an example in which the selection condition is such a condition that both the index X(i, j) and the index X(j, i) are less than a predetermined threshold. The selection condition, however, may be such a condition that the index X(i, j) is less than a predetermined threshold. That is, the selection condition may be a condition independent of the index X(j, i). Alternatively, the selection condition may be such a condition that the index X(j, i) is less than a predetermined threshold. That is, the selection condition may be a condition independent of the index X(i, j).

As a result of the determination in the step S223, when it is determined that the selection condition is satisfied (step S223: Yes), the selection unit 219 finally selects the wireless terminal and the beam B temporarily selected in the step S222, as a new wireless terminal 10 serving as the communication target of the base station apparatus 20 and a new beam B used to communicate with the new wireless terminal 10 (step S224). That is, the selection unit 219 finally determines the wireless terminal 10 and the beam B temporarily selected in the step S222, as the new wireless terminal 10 serving as the communication target of the base station apparatus 20 and the new beam B used to communicate with the new wireless terminal 10 (step S224).

On the other hand, as a result of the determination in the step S223, when it is determined that the selection condition is not satisfied (step S223: No), the selection unit 219 does not finally select the wireless terminal 10 and the beam B temporarily selected in the step S222, as the wireless terminal 10 serving as the communication target of the base station apparatus 20 and the beam B used to communicate with the wireless terminal 10 serving as the selection unit 219 cancels the temporal selection of the wireless terminals 10 and the beam B in the step S222.

Then, the selection unit 219 determines whether or not a predetermined end condition to be satisfied in order to end the combination selection operation is satisfied (step S225). The end condition may include such a condition that the number of the wireless terminals 10 selected in the step S221 and the step S224 reaches a predetermined number. The end condition may include such a condition that all the remaining wireless terminals 10, excluding the wireless terminals 10 selected in the step S221, among the plurality of wireless terminals 10 provided by the wireless communication system 1 are temporarily selected in the step S222.

As a result of the determination in the step S225, when it is determined that the end condition is not satisfied (step S225: No), the selection unit 219 performs the step S222 to the step 225 again. That is, the selection unit 219 temporarily selects a new combination of the wireless terminal 10 and the beams B (the step S222), and determines whether or not the predetermined selection condition based on the index X corresponding to the temporarily selected new combination is satisfied (the step S223).

On the other hand, as a result of the determination in the step S225, when it is determined that the end condition is satisfied (step S225: Yes), the selection unit 219 ends the combination selection operation illustrated in FIG. 12.

### <2-3> Technical Effect of Wireless Communication System 1

As described above, in the wireless communication system 1 in the second example embodiment, the control apparatus 21 selects the combination of at least one wireless terminal 10 serving as the communication target and at least one beam B used for the communication, on the basis of the index X indicating the relationship between the plurality of beams B. Specifically, for example, the control apparatus 21 may select the combination of the wireless terminal 10 and the beam B such that the error rate is less than a predetermined threshold, on the basis of the index X (e.g., error rate). Here, typically, the index X (e.g., error rate) increases with increasing degree of the interference between the beam B used by the wireless apparatus 22-1 and the beam B used by the wireless apparatus 22-2 increases. Therefore, the control apparatus 21 may substantially select the combination of the wireless terminal 10 and the beam B so as to reduce the degree of the interference between the beam B used by the wireless apparatus 22-1 and the beam B used by the wireless apparatus 22-2, on the basis of the index X. That is, the control apparatus 21 may substantially select the combination of the wireless terminal 10 and the beam B so as to reduce the interference between the beam B used by the wireless apparatus 22-1 and the beam B used by the wireless apparatus 22-2, on the basis of the index X. Therefore, compared with a control apparatus in a comparative example in which the combination of the wireless terminal 10 and the beam B is selected without using the index X, the control apparatus 21 is allowed to select the combination of the wireless terminal 10 and the beam B so as to reduce the interference of the plurality of beams B used to communicate with the plurality of wireless terminals 10. That is, the control apparatus 21 is allowed to reduce the interference of the plurality of beams B used to communicate with the plurality of wireless terminals 10.

Especially, the control apparatus 21 in the second example embodiment does not need to estimate the positions of the plurality of wireless terminals 10 on the assumption that the communication environment of the plurality of wireless terminals 10 using the plurality of beams B is a line-of-sight environment, in order to select the combination of the wireless terminal 10 and the beam B. Therefore, even when the communication environment of the plurality of wireless terminals 10 using the plurality of beams B is a non-line-of-sight or over-the-horizon environment, the control apparatus 21 is allowed to reduce the interference of the plurality of beams B used to communicate with the plurality of wireless terminals 10.

### <3> Modified Examples of Wireless Communication System 1

Next, modified examples of the wireless communication system 1 will be described.

The following modified examples may be applied to the control apparatus 1000 in the first example embodiment.

### <3-1> First Modified Example

In the above description, the control apparatus 21 (especially, the selection unit 219) selects the combination of the wireless terminal 10 and the beam B that satisfies such a selection condition that at least one of the index X(1#i, 2#j) and the index X(2#j, 1#i) is less than a predetermined threshold, in the step S224 in FIG. 12. On the other hand, in a first modified example, the selection unit 219 may preferentially select the combination of the wireless terminal 10 and the beam B in which at least one of the index X(1#i, 2#j) and the index X(2#j, 1#i) is low, in the step S224 in FIG. 12.

For example, the selection unit 219 may preferentially select the combination of the wireless terminal 10 and the beam B in which the index X(1#i, 2#j) is low. For example, the selection unit 219 may preferentially select the combination of the wireless terminal 10 and the beam B in which the index X(2#j, 1#i) is low. For example, the selection unit 219 may preferentially select the combination of the wireless terminal 10 and the beam B in which the sum of the index X(1#i, 2#j) and the index X(2#j, 1#i) is low.

Even in the first modified example, the control apparatus 21 is allowed to reduce the interferences of the plurality of beams B used to communicate with the plurality of wireless terminals 10.

### <3-2> Second Modified Example

In a second modified example, the index calculation unit 218 may calculate the index X indicating the relationship between the connection beam Bc and the interference beam Bi, for each position at which the communication using the connection beam Bc is performed. The position at which the communication using the connection beam Bc is performed may mean the position of the wireless terminal 10 that communicates with the base station apparatus 20 by using the connection beam Bc. In particular, the position at which the communication using the connection beam Bc is performed may mean the position of the wireless terminal 10 in the coverage area of the wireless apparatus 22 that communicates with the wireless terminal 10 by using the connection beam Bc. In the following description, the position at which the communication using the connection beam Bc is performed, is simply referred to as a “communication position”.

In order to calculate the index X for each communication position, the index calculation unit 218 may set a plurality of position groups on the basis of the communication position, and may associate the calculated index X with at least one of the plurality of position groups. That is, the index calculation unit 218 may calculate the index X for each position group. As an example, the index calculation unit 218 may set a first position group corresponding to a first region in the coverage area of the wireless apparatus 22, and a second position group corresponding to a second region that is different from the first region in the coverage area of the wireless apparatus 22. The first region in the coverage area may include a region near the center of the coverage area. The second region in the coverage area may include a region near the edge of the coverage area. In this case, the index calculation unit 218 may calculate the index X associated with the first position group, on the basis of a communication availability information about the availability of the communication with the wireless terminal 10 disposed in the first region of the coverage area. On the other hand, the index calculation unit 218 may calculate the index X associated with the second position group, on the basis of a communication availability information about the availability of the communication with the wireless terminal 10 disposed in the second region of the coverage area.

The index calculation unit 218 may set the plurality of position groups such that a plurality of regions respectively corresponding to the plurality of position groups have the same area. For example, the index calculation unit 218 may set the plurality of position groups such that the first region corresponding to the first position group has the same area as that of the second region corresponding to the second position group. In the second modified example, the state in which “two regions have the same area” may include a state in which “two regions have completely the same area”. In the second modified example, the state in which “two regions have the same area” may include a state in which “two regions do not have completely the same area, but a difference between the areas of the two regions is less than or equal to an allowable amount”.

The index calculation unit 218 may set the plurality of position groups, on the basis of a difference in the index X between the plurality of position groups. For example, the index calculation unit 218 may divide the coverage area into a plurality of regions on the basis of the difference in the index X between the plurality of position groups, thereby set a plurality of position groups respectively corresponding to the plurality of regions. For example, the index calculation unit 218 may further divide one region in the coverage area corresponding to one position group into a plurality of regions, on the basis of the difference in the index X between the plurality of position groups, thereby further divide one position group into a plurality of position groups. For example, the index calculation unit 218 may combine at least two position groups to generate a new position group, on the basis of the difference in the index X between the plurality of position groups.

In order to calculate the index X for each communication position, the index calculation unit 218 may obtain information about the position of the wireless terminal 10 (i.e., information about the communication position) from the wireless terminal 10. For example, the index calculation unit 218 may obtain the information about the position of the wireless terminal 10 that is obtained by the wireless terminal 10 using a GPS (Global Positioning System). For example, the index calculation unit 218 may obtain the information about the position of the wireless terminal 10 that is obtained by the wireless terminal 10 using a position measuring system that is different from the GPS.

In the step S223 of FIG. 12, the selection unit 219 may determine whether or not the selection condition is satisfied, by using the index X associated with the position group corresponding to the position (communication position) of the wireless terminal 10 temporarily selected in the step S222 in FIG. 12. For example, when the wireless terminal 10 temporarily selected in the step S222 is disposed in the region near the center of the coverage area, the selection unit 219 may determine whether or not the selection condition is satisfied, by using the index X associated with the position group corresponding to the region near the center of the coverage area. For example, when the wireless terminal 10 temporarily selected in the step S222 is disposed in the region near the edge of the coverage area, the selection unit 219 may determine whether the selection condition is satisfied, by using the index X associated with the position group corresponding to the region near the edge of the coverage area.

In the step S223 in FIG. 12, the selection unit 219 may determine whether or not the selection condition is satisfied, by using the index X associated with the position group corresponding to the position (communication position) of the wireless terminal 10 selected in the step S221 in FIG. 12. For example, when the wireless terminal 10 selected in the step S221 is disposed in the region near the center of the coverage area, the selection unit 219 may determine whether or not the selection condition is satisfied, by using the index X included in the position group corresponding to the region near the center of the coverage area. For example, when the wireless terminal 10 selected in the step S221 is disposed in the region near the edge of the coverage area, the selection unit 219 may determine whether or not the selection condition is satisfied, by using the index X included in the position group corresponding to the region near the edge of the coverage area.

Here, depending on the position in the coverage area, the interference beam Bi interfering with the connection beam Bc may change. For example, the interference beam Bi interfering with the connection beam Bc used by the wireless terminal 10 disposed in the region near the center of the coverage area may be different from the interference beam Bi interfering with the connection beam Bc used by the wireless terminal 10 disposed in the region near the edge of the coverage area. Then, in the second modified example, the index calculation unit 218 is allowed to calculate the index X indicating the degree of the interference between the plurality of beams B with higher accuracy, by calculating the index X for each communication position. Consequently, the control apparatus 21 is further allowed to reduce the interferences of the plurality of beams B used to communicate with the plurality of wireless terminals 10.

### <3-3> Third Modified Example

In a third modified example, the index calculation unit 218 may calculate the index X indicating the relationship between the connection beam Bc and the interference beam Bi, for each received quality of the connection beam Bc. That is, the third modified example is different from the second modified example in that the index X is calculated for each received quality of the connection beam Bc, in addition to or in place of the communication position. Other features of the third modified example may be the same as those of the second modified example. Therefore, a detailed description of the third modified example will be omitted, but an outline thereof will be briefly described below.

In order to calculate the index X for each received quality, the index calculation unit 218 may set a plurality of received quality groups on the basis of the received quality, and may associate the calculated index X, with at least one of the plurality of received quality groups. That is, the index calculation unit 218 may calculate the index X for each received quality group. As an example, the index calculation unit 218 may set a first received quality group corresponding to the received quality included in a first quality range, and a second received quality group corresponding to the received quality included in a second quality range that is different from the first quality range. In this case, the index calculation unit 218 may calculate the index X associated with the first received quality group, on the basis of a communication availability information about the availability of the communication with the wireless terminal 10 using the connection-beam Bc of the received quality included in the first quality range. On the other hand, the index calculation unit 218 may calculate the index X associated with the second received quality group, on the basis of a communication availability information about the availability of the communication with the wireless terminal 10 using the connection-beam Bc of the received quality included in the second quality range.

The index calculation unit 218 may set the plurality of received quality groups such that a difference in received quality between the plurality of received quality groups is the same. For example, the index calculation unit 218 may set the plurality of received quality groups such that a difference between the received quality corresponding to the first received quality group and the received quality corresponding to the second received quality group, a difference between the received quality corresponding to the first received quality group and the received quality corresponding to the third received quality group, and a difference between the received quality corresponding to the second received quality group and the received quality corresponding to the third received quality group are the same. In the third modified example, the state in which “two differences are the same” may include such a state in which “two differences are completely the same”. In the third modified example, the state in which “two differences are the same” may include a state in which “two differences are not completely the same, but a difference between the two differences is less than or equal to an allowable amount.”

The index calculation unit 218 may set the plurality of received quality groups, on the basis of a difference in the index X between the plurality of received quality groups. For example, the index calculation unit 218 may further divide one received quality group into a plurality of received quality groups, on the basis of the difference in the index X between the plurality of received quality groups. For example, the index calculation unit 218 may combine at least two received quality groups to generate a new received quality group, on the basis of the difference in the index X between the plurality of received quality groups.

In order to calculate the index X for each received quality, the index calculation unit 218 may obtain information about the received quality of the connection beam Bc from the wireless terminal 10. For example, the wireless terminal 10 may calculate the received quality of the connection beam Bc by using a reference signal transmitted from the wireless apparatus 22. An example of the received quality is at least one of RSRP (Reference Signal Received Power), RSRQ (Reference Signal Received Quality), and SINR (Signal to Interference plus Noise Ratio). The wireless terminal 10 may transmit a calculation result of the received quality of the connection beam Bc, to the base station apparatus 20. Consequently, the index calculation unit 218 is allowed to obtain the information about the received quality of the connection beam Bc.

In the step S223 in FIG. 12, the selection unit 219 may determine whether or not the selection condition is satisfied, by using the index X associated with the received quality group corresponding to the received quality of the connection beam Bc used to communicate with the wireless terminal 10 temporarily selected in the step S222 in FIG. 12. Similarly, in the step S223 in FIG. 12, the selection unit 219 may determine whether or not the selection condition is satisfied, by using the index X associated with the received quality group corresponding to the received quality of the connection beam Bc used to communicate with the wireless terminal 10 selected in the step S221 in FIG. 12.

Here, depending on the position in the coverage area, the received quality of the connection beam Bc may change. For example, the received quality of the connection beam Bc used by the wireless terminal 10 disposed in the region near the center of the coverage area may be different from the received quality of the connection beam Bc used by the wireless terminal 10 disposed in the region near the edge of the coverage area. Consequently, depending on the position in the coverage area, the interference beam Bi interfering with the connection beam Bc may change. Then, in the third modified example, the index calculation unit 218 is allowed to calculate the index X indicating the degree of the interference between the plurality of beams B with higher accuracy, by calculating the index X for each received quality. Consequently, the control apparatus 21 is further allowed to reduce the interference of the plurality of beams B used to communicate with the plurality of wireless terminals 10.

### <3-4> Fourth Modified Example

In a fourth modified example, the index calculation unit 218 may calculate the index X indicating the relationship between the connection beam Bc and the interference beam Bi, for each received quality of the plurality of beams B. That is, the fourth modified example is different from the third modified example in that the index X is calculated for each received quality of the plurality of beams B, in addition to or in place of the received quality of the connection beam Bc. Other features of the fourth modified example may be the same as those of the third modified example. Therefore, a detailed description of the fourth modified example will be omitted, but an outline thereof will be briefly described below.

In order to calculate the index X for each received quality of the plurality of beams B, even in the fourth modified example, similarly to the third modified example, the index calculation unit 218 may set a plurality of received quality groups on the basis of the received quality, and may associate the calculated index X with at least one of the plurality of received quality groups. As an example, the index calculation unit 218 may set a first received quality group in which a feature quantity of the received quality of the plurality of beams B is included in a first feature quantity range, and a second received quality group in which the feature quantity of the received quality of the plurality of beams B is included in a second feature range that is different from the first feature range.

In order to calculate the index X for each received quality of the plurality of beams B, the index calculation unit 218 may calculate a degree of similarity between the received quality of the plurality of beams B in a period in which the base station apparatus 20 communicates with one wireless terminal 10 and the received quality corresponding to each of the plurality of received quality groups. An example of the degree of similarity is a cosine similarity degree of a (m+n)-dimensional vector having the received quality of the plurality of beams B as a vector element. When the plurality of beams B includes the beam B whose received quality is not calculated, the received quality of the beam B may be regarded as a predetermined value (e.g., zero or a value that is different from zero). Then, the index calculation unit 218 may associate the index X calculated on the basis of the communication availability information about the availability of the communication with the one wireless terminal 10, with one received quality group having the highest degree of similarity.

The index calculation unit 218 may set the plurality of received quality groups by performing clustering that is an example of unsupervised learning. For example, the index calculation unit 218 may obtain a plurality of sample informations including the received quality of the plurality of beams B, and may classify the plurality of sample informations by the clustering. In this case, each cluster classified by the clustering may be used as the received quality group.

The index calculation unit 218 may set the plurality of received quality groups, on the basis of a difference in the index X between the plurality of received quality groups. For example, the index calculation unit 218 may further divide one received quality group into a plurality of received quality groups, on the basis of the difference in the index X between the plurality of received quality groups. For example, the index calculation unit 218 may combine at least two received quality groups to generate a new received quality group, on the basis of the difference in the index X between the plurality of received quality groups.

In order to calculate the index X for each received quality, the index calculation unit 218 may obtain information about the received quality of the plurality of beams B from the wireless terminal 10. For example, the wireless terminal 10 may calculate the received quality of the plurality of beams B by using a reference signal transmitted from the wireless apparatus 22. An example of the received quality is at least one of RSRP (Reference Signal Received Power), RSRQ (Reference Signal Received Quality), and SINR (Signal to Inteference plus Noise Ratio). The wireless terminal 10 may transmit a calculation result of the received quality of the plurality of beams B to the base station apparatus 20. Consequently, the index calculation unit 218 is allowed to obtain the information about the received quality of the plurality of beams B.

In the S223 in FIG. 12, the selection unit 219 may determine whether or not the selection condition is satisfied, by using the index X associated with the received quality group corresponding to the received quality of the plurality of beams B at the time.

In the fourth modified example as described above, the index calculation unit 218 is allowed to calculate the index X for each region in which the received quality of the plurality of beams B is similar. Therefore, the index calculation unit 218 is allowed to calculate the index X indicating the degree of the interference between the plurality of beams B with higher accuracy. Consequently, the control apparatus 21 is further allowed to reduce the interference of the plurality of beams B used to communicate with the plurality of wireless terminals 10.

### <3-5> Fifth Modified Example

In the above description, the index calculation unit 218 calculates the error rate as an example of the index X. In the fifth modified example, the index calculation unit 218 may calculate the index X that is different from the error rate. For example, the index calculation unit 218 may calculate the inverse of the error rate as the index X. For example, the index calculation unit 218 may calculate a success rate of the communication as the index X. For example, the index calculation unit 218 may calculate the number of errors per unit time as the index X.

When the number of errors per unit time is used as the index X, the index X increases with increasing degree of the interference between the beam B used by the wireless apparatus 22-1 and the beam B used by the wireless apparatus 22-2, as in the case where the error rate is used as the index X. Therefore, when the number of errors per unit time is used as the index X, the selection unit 219 may select the combination of the wireless terminal 10 and the beams B by using the selection condition that both the index X(i, j) and the index X(j, i) are less than a predetermined threshold, as in the case where the error rate is used as the index X. Alternatively, the selection unit 219 may preferentially select the combination of the wireless terminal 10 and the beam B in which at least one of the index X(i, j) and the index X(j, i) is low.

On the other hand, when at least one of the inverse of the error rate and the success rate of the communication is used as the index X, unlike when the error rate is used as the index X, the index X decreases with increasing degree of the interference between the beam B used by the wireless apparatus 22-1 and the beam B used by the wireless apparatus 22-2. In this case, the selection unit 219 may select the combination of the wireless terminal 10 and the beam B by using such a selection condition that both the index X(i, j) and the index X(j, i) are greater than a predetermined threshold. Alternatively, the selection unit 219 may preferentially select the combination of the wireless terminal 10 and beam B in which at least one of the index X(i, j) and the index X(j, i) is high.

### <3-6> Sixth Modified Example

The control apparatus 21 may change the number of the beams B used to communicate with the wireless terminal 10 in accordance with a communication volume. As an example, the control apparatus 21 may change the number of the beams B used to communicate with the wireless terminal 10 such that the number of the beams B used to communicate with the wireless terminal 10 when the communication volume is a first volume, is greater than the number of the beams B used to communicate with the wireless terminal 10 when the communication volume is a second volume that is lower than the first volume.

When the number of the beams B used to communicate with the wireless terminal 10 is changed, the index calculation unit 218 may calculate the index X for each number of the beams B used to communicate with the wireless terminal 10. That is, the index calculation unit 218 may calculate the index X for each number of the beams B, as in the case of calculating the index X for each communication position, which is described in the second modified example.

The control apparatus 21 may change the shape of at least one beam B used to communicate with the wireless terminal 10 in accordance with the communication volume. As an example, the control apparatus 21 may change the shape of the beam B used to communicate with the wireless terminal 10 such that the width of the beam B used to communicate with the wireless terminal 10 when the communication volume is the first volume, is greater than the width of the beam B used to communicate with the wireless terminal 10 when the communication volume is a third volume that is higher than the first volume.

The control apparatus 21 may change the shape of at least one beam B used to communicate with the wireless terminal 10 in accordance with the number of the beams B used to communicate with the wireless terminal 10. As an example, the control apparatus 21 may change the shape of the beam B used to communicate with the wireless terminal 10 such that the width of the beam B used to communicate with the wireless terminal 10 when the number of the beams B used to communicate with the wireless terminal 10 is a first number, is greater than the width of the beam B used to communicate with the wireless terminal 10 when the number of the beams B used to communicate with the wireless terminal 10 is a third number that is greater than the first number.

When the shape of the beam B is changed, the index calculation unit 218 may calculate the index X for each shape of the beam B. That is, the index calculation unit 218 may calculate the index X for each shape of the beams B, as in the case of calculating the index X for each communication position, which is described in the second modified example.

### <3-7> Seventh Modified Example

The control apparatus 21 may change the number of the wireless apparatuses 22 that actually operate, in accordance with the communication volume. That is, the control apparatus 21 may change the number of the wireless apparatuses 22 that actually communicate with the wireless terminal 10, in accordance with the communication volume. As an example, the control apparatus 21 may change the number of the operating wireless apparatuses 22 such that the number of the operating wireless apparatuses 22 when the communication volume is the first volume, is greater than the number of the operating wireless apparatuses 22 when the communication volume is the second volume that is less than the first volume.

When the number of the operating wireless apparatuses 22 is changed, the index calculation unit 218 may calculate the index X for each number of the operating wireless apparatuses 22. That is, the index calculation unit 218 may calculate the index X for each number of the operating wireless apparatuses 22, as in the case of calculating the index X for each communication position, which is described in the second modified example.

The control apparatus 21 may change the number of at least one beam B used to communicate with the wireless terminal 10 in accordance with the number of the operating wireless apparatuses 22. The control apparatus 21 may change the number of the beams B used to communicate with the wireless terminal 10 such that the number of the beams B used to communicate with the wireless terminal 10 when the number of the operating wireless apparatuses 22 is a first number is more than the number of beams B used to communicate with the wireless terminal 10 when the number of operating wireless apparatus 22 is a second number that is less than the first number. As a consequence, even when the number of the operating wireless apparatuses 22 is reduced, the coverage area of the wireless apparatus 22 expands, and thus, the base station apparatus 20 is allowed to properly communicate with the wireless terminal 10.

The control apparatus 21 may change the shape of at least one beam B used to communicate with the wireless terminal 10 in accordance with the number of the operating wireless apparatuses 22. The control apparatus 21 may change the shape of the beam B used to communicate with the wireless terminal 10 such that the width of the beam B used to communicate with the wireless terminal 10 when the number of the operating wireless apparatuses 22 is the first number, is greater than the width of the beam B used to communicate with the wireless terminal when the number of the operating wireless apparatuses 22 is the second number that is less than the first number. As a consequence, even when the number of the operating wireless apparatuses 22 is reduced, the coverage area of the wireless apparatus 22 expands, and thus, the base station apparatus 20 is allowed to properly communicate with the wireless terminal 10.

### <3-8> Eighth Modified Example

At least one wireless apparatus 22 may be configured to communicate with one wireless terminal 10, by using at least two beams B at the same time. At least one wireless apparatus 22 may be configured to communicate with at least two wireless terminals 10, by using at least two beams B at the same time.

For example, the wireless apparatus 22-1 may be configured to communicate with at least one wireless terminal 10, by using at least two of the plurality of beams B1#1 to B1#m at the same time. In this case, the index calculation unit 218 may calculate the index X indicating the relationship between at least two of the plurality of beams B1#1 to B1#m, as the index X indicating the relationship between the plurality of beams B.

For example, the wireless apparatus 22-2 may be configured to communicate with at least one wireless terminal 10, by using at least two of the plurality of beams B2#1 to B2#n at the same time. In this case, the index calculation unit 218 may calculate the index X indicating the relationship between at least two of the plurality of beams B2#1 to B2#n, as the index X indicating the relationship between the plurality of beams B.

As an example, it is described that the wireless apparatus 22-1 communicates with the wireless terminal 10 by using beams B1#a and B1#b, and that the wireless apparatus 22-2 communicates with the wireless terminal 10 by using a beam B2#c. Each of a and b is a variable indicating an integer that is greater than or equal to 1 and is less than or equal to m, c is a variable indicating an integer that is greater than or equal to 1 and is less than or equal to n. In this case, the index calculation unit 218 may calculate at least one of the following: an index X(1#a, 1#b) indicating the relationship between the beam B1#a and the beam B1#b in the situation in which the beam B1#a is the connection beam Bc and the beam B1#b is the interference beam Bi, an index X(1#a, 2#c) indicating the relationship between the beam B1#a and the beam B2#c in the situation in which the beam B1#a is the connection beam Bc and the beam B2#c is the interference beam Bi, an index X(1#b, 1#a) indicating the relationship between the beam B1#b and the beam B1#a in the situation in which the beam B1#b is the connection beam Bc and the beam B1#a is the interference beam Bi, an index X(1#b, 2#c) indicating the relationship between the beam B1#b and the beam B2#c in the situation in which the beam B1#b is the connection beam Bc and the beam B2#c is the interference beam Bi, an index X(2#c, 1#a) indicating the relationship between the beam B2#c and the beam B1#a in the situation in which the beam B2#c is the connection beam Bc and the beam B1#a is the interference beam Bi, and an index X(2#c, 1#b) indicating the relationship between the beam B2#c and the beam B1#b in the situation in which the beam B2#c is the connection beam Bc and the beam B1#b is the interference beam Bi.

### <3-9> Ninth Modified Example

The functions of each apparatus described above (e.g., at least one of the wireless terminal the base station apparatus 20, the control apparatus 21, the wireless apparatus 22, and the control apparatus 1000) may be realized or implemented by software. The functions of each apparatus described above may be realized or implemented by hardware. The functions of each apparatus described above may be realized or implemented by a combination of software and hardware. A program code (an instruction) that constitutes the software may be stored in a computer-readable recording medium in an inside or outside of each apparatus, for example. The program code may be read into memory in execution thereof and may be executed by the processor. Furthermore, a computer-readable non-transitory recording medium on which the program code is recorded, may also be provided.

For example, FIG. 13 is a diagram illustrating a combination of software and hardware for realizing the functions of the control apparatus 1000 described in the first example embodiment. An information processing apparatus 2000 includes a non-transitory recording medium 2001, a memory 2002, and a processor 2003. The non-transitory recording medium 2001, the memory 2002, and the processor 2003 are connected to each other through an internal bus 2004. The non-transitory recording medium 2001 records thereon a program code that realizes or implements functional blocks of the control apparatus 1000 (specifically, a calculation unit 1001 and a selection unit 1002). The program code for realizing or implementing the functional blocks of the control apparatus 1000 is read into the memory 2002. The processor 2003 executes the program code read into the memory 2002, thereby perform the processes of the function block of the control apparatus 1000. In the same manner, each of the wireless terminal 10, the base station apparatus 20, the control apparatus 21, and the wireless apparatus 22 may be realized or implemented by a combination of a non-transitory recording medium, a memory, and a processor.

According to the control apparatus, the control method, and the computer program in example aspects of this disclosure, it is possible to reduce the interference of a plurality of beams used to communicate with a plurality of wireless terminals.

### <4> Supplementary Notes

With respect to the example embodiments described above, the following Supplementary Notes are further disclosed.

[Supplementary Note 1]

A control apparatus that controls a communication with a plurality of wireless terminals using a plurality of beams,
the control apparatus including: at least one memory configured to store instructions; and at least one processor,
the at least one processor being configured to execute the instructions to:
calculate an index indicating a relationship between the plurality of beams, on the basis of a first information about a success/failure of a communication with at least two of the plurality of wireless terminals, and a second information indicating a combination pattern of at least two of the plurality of beams that are used a communication whose success/failure is indicated by the first information; and
select, from among the plurality of wireless terminals and the plurality of beams, a combination of at least one wireless terminal serving as a communication target and at least one beam used to communicate with the at least one wireless terminal, on the basis of the index.

[Supplementary Note 2]

The control apparatus according to Supplementary Note 1, wherein
the index indicates a degree of interference of a communication using a second beam of the plurality of beams with respect to a communication using a first beam of the plurality of beams.

[Supplementary Note 3]

The control apparatus according to Supplementary Note 2, wherein
the at least one processor is configured to execute the instructions to select, from among the plurality of wireless terminals and the plurality of beams, a combination of at least two wireless terminals serving as communication targets and at least two beams used to communicate with the at least two wireless terminals such that the index corresponding to the selected at least two beams is less than a predetermined threshold.

[Supplementary Note 4]

The control apparatus according to Supplementary Note 2, wherein
the at least one processor is configured to execute the instructions to select the combination of the at least one wireless terminal and the at least one beam, by preferentially selecting a combination of a wireless terminal and a beam in which the corresponding index is low.

[Supplementary Note 5]

The control apparatus according to Supplementary Note 2, wherein
the at least one processor is configured to execute the instructions to set a plurality of groups on the basis of at least one of a position at which the communication using the first beam is performed and a received quality of the first beam, and calculate the index corresponding to at least one of the plurality of groups.

[Supplementary Note 6]

The control apparatus according to Supplementary Note 1, wherein
the at least one processor is configured to execute the instructions to set a plurality of groups on the basis of a received quality of the plurality of beams, and calculate the index corresponding to at least one of the plurality of groups.

[Supplementary Note 7]

The control apparatus according to Supplementary Note 6, wherein
the at least one processor being configured to execute the instructions to set the plurality of groups on the basis of a degree of similarity of the received quality of the plurality of beams.

[Supplementary Note 8]

The control apparatus according to Supplementary Note 1, wherein
the control apparatus is connected to at least one wireless apparatus that forms the plurality of beams, and controls a communication with the plurality of wireless terminals through the at least one wireless apparatus.

[Supplementary Note 9]

A control method that controls a communication with a plurality of wireless terminals using a plurality of beams, the control method including:
calculating an index indicating a relationship between the plurality of beams, on the basis of a first information about a success/failure of a communication with at least two of the plurality of wireless terminals, and a second information indicating a combination pattern of at least two of the plurality of beams that are used a communication whose success/failure is indicated by the first information; and
selecting, from among the plurality of wireless terminals and the plurality of beams, a combination of at least one wireless terminal serving as a communication target and at least one beam used to communicate with the at least one wireless terminal, on the basis of the index.

[Supplementary Note 10]

A computer program that allows a computer to execute a control method that controls a communication with a plurality of wireless terminals using a plurality of beams,
the control method including:
calculating an index indicating a relationship between the plurality of beams, on the basis of a first information about a success/failure of a communication with at least two of the plurality of wireless terminals, and a second information indicating a combination pattern of at least two of the plurality of beams that are used a communication whose success/failure is indicated by the first information; and
selecting, from among the plurality of wireless terminals and the plurality of beams, a combination of at least one wireless terminal serving as a communication target and at least one beam used to communicate with the at least one wireless terminal, on the basis of the index.

At least a part of the constituent elements of the above-described example embodiments and modified examples can be combined with at least another part of the constituent elements of the above-described example embodiments and modified examples, as appropriate. A part of the constituent elements of the above-described example embodiments and modified examples may not be used. Furthermore, to the extent permitted by law, all of the publications cited in the above-described example embodiments and the disclosure of the U.S. patent are incorporated herein by reference.

This disclosure is not limited to the above-described examples and is allowed to be changed, if desired, without departing from the essence or spirit of the invention which can be read from the claims and the entire specification. A control apparatus, a control method, a computer program, and a recording medium with such changes, are also included in the technical concepts of this disclosure.

### DESCRIPTION OF REFERENCE NUMERALS

1 Wireless communication system
10 Wireless terminal
20 Base station apparatus
21 Control apparatus
218 Index calculation unit
219 Selection unit
22 Wireless apparatus

What is claimed is:

1. A control apparatus that controls a communication with a plurality of wireless terminals using a plurality of beams,
the control apparatus comprising: at least one memory configured to store instructions; and at least one processor,
the at least one processor being configured to execute the instructions to:
calculate an index indicating a relationship between the plurality of beams, on the basis of a first information about a success/failure of a communication with at least two of the plurality of wireless terminals, and a second information indicating a combination pattern of at least two of the plurality of beams that are used a communication whose success/failure is indicated by the first information; and
select, from among the plurality of wireless terminals and the plurality of beams, a combination of at least one wireless terminal serving as a communication target and at least one beam used to communicate with the at least one wireless terminal, on the basis of the index.

2. The control apparatus according to claim 1, wherein
the index indicates a degree of interference of a communication using a second beam of the plurality of beams with respect to a communication using a first beam of the plurality of beams.

3. The control apparatus according to claim 2, wherein
the at least one processor is configured to execute the instructions to select, from among the plurality of wireless terminals and the plurality of beams, a combination of at least two wireless terminals serving as communication targets and at least two beams used to communicate with the at least two wireless terminals such that the index corresponding to the selected at least two beams is less than a predetermined threshold.

4. The control apparatus according to claim 2, wherein
the at least one processor is configured to execute the instructions to select the combination of the at least one wireless terminal and the at least one beam, by preferentially selecting a combination of a wireless terminal and a beam in which the corresponding index is low.

5. The control apparatus according to claim 2, wherein
the at least one processor is configured to execute the instructions to set a plurality of groups on the basis of at least one of a position at which the communication using the first beam is performed and a received quality of the first beam, and calculate the index corresponding to at least one of the plurality of groups.

6. The control apparatus according to claim 1, wherein
the at least one processor is configured to execute the instructions to set a plurality of groups on the basis of a received quality of the plurality of beams, and calculate the index corresponding to at least one of the plurality of groups.

7. The control apparatus according to claim 6, wherein
the at least one processor being configured to execute the instructions to set the plurality of groups on the basis of a degree of similarity of the received quality of the plurality of beams.

8. The control apparatus according to claim 1, wherein
the control apparatus is connected to at least one wireless apparatus that forms the plurality of beams, and controls a communication with the plurality of wireless terminals through the at least one wireless apparatus.

9. A control method that controls a communication with a plurality of wireless terminals using a plurality of beams,
the control method comprising:
calculating an index indicating a relationship between the plurality of beams, on the basis of a first information about a success/failure of a communication with at least two of the plurality of wireless terminals, and a second information indicating a combination pattern of at least two of the plurality of beams that are used a communication whose success/failure is indicated by the first information; and
selecting, from among the plurality of wireless terminals and the plurality of beams, a combination of at least one wireless terminal serving as a communication target and at least one beam used to communicate with the at least one wireless terminal, on the basis of the index.

10. A non-transitory recording medium that records thereon a computer program that allows a computer to execute a control method that controls a communication with a plurality of wireless terminals using a plurality of beams,
the control method including:
calculating an index indicating a relationship between the plurality of beams, on the basis of a first information about a success/failure of a communication with at least two of the plurality of wireless terminals, and a second information indicating a combination pattern of at least two of the plurality of beams that are used a communication whose success/failure is indicated by the first information; and
selecting, from among the plurality of wireless terminals and the plurality of beams, a combination of at least one wireless terminal serving as a communication target and at least one beam used to communicate with the at least one wireless terminal, on the basis of the index.
